(19) United States
(12) Patent Application Publication
(10) Pub. No.: US 2022/0207986 A1
(43) Pub. Date: Jun. 30, 2022

(54) MONITORING SYSTEM

(71) Applicant: VESTA S.R.L., BIBBIENA (AR) (IT)

(72) Inventors: MICHELE GABICCINI, POPPI (IT); GIANLUCA SACCHI, BIBBIENA (IT)

(21) Appl. No.: 17/605,665

(22) PCT Filed: Apr. 22, 2020
(86) PCT No.: PCT/IB2020/053795

§ 371 Date: Oct. 22, 2021

(30) Foreign Application Priority Data
Apr. 23, 2019 (IT) 102019000006244

(51) Int. Cl. G08B 25/10; G08B 25/00; G01D 21/02; H04W 4/33

(52) U.S. Cl. CPC G08B 25/10; H04W 4/33; G01D 21/02; G08B 25/006

(57) ABSTRACT

Described is a monitoring system comprising a plurality of sensors (2) and a control unit (3). The sensors (2) can be installed in a building (E) or in locations intended for other use, and are configured for detecting a respective plurality of ambient parameters of the building (E) and for transmitting parametric signals representing the ambient parameters. The control unit (3) is configured to receive the parametric signals and is connected or connectable to a database which comprises a plurality of predetermined reference values. The control unit (3) is further configured for comparing the parametric signals with the plurality of predetermined reference values and for generating an alarm signal as a function of a result of the comparison.

### TECHNICAL FIELD

This invention relates to the technical sector for the building and maintenance of structures.

In particular, the invention relates to a monitoring system for man-made and/or natural structures such as, for example, for buildings or for premises for other purposes, for example museums, or natural geographical sites or lighting infrastructures.

### BACKGROUND ART

The need is strongly felt in the trade for simple and economic solutions which satisfy the increasing need for real and perceived safety and reliability, allowing both individuals and authorities to have an overall and accurate view of the conditions of a building and of the rooms present inside it and of the surrounding environment.

In particular, with regard to buildings for private and public use, it is necessary, both in situations of normal control and in the case of extraordinary events or disasters, to be able to guarantee with certainty the condition of the structure and prevent as much as possible the occurrence of hazardous situations for the occupants and potentially destructive conditions for the building, such as, for example, fires or collapses.

Similarly, even in the case of buildings with different uses, for example with particular historical and/or cultural interest, further precautions might be necessary to ensure the maintenance of ambient conditions, such as humidity and aeration levels, which prevent the deterioration of the exposed works.

In any case, it is also essential to be able to intervene in a rapid manner, organising, each time it is necessary, a maintenance, repair and/or saving operation, in response to the occurrence of a hazardous situation both inside and near the building.

### DISCLOSURE OF THE INVENTION

In this context, the technical purpose which forms the basis of the invention is to provide a monitoring system for man-made and/or natural structures which is able to quickly determine any need for maintenance and/or repair and/or saving operations to be carried out on a given area rather than on a building or in its proximity.

The technical purpose indicated and the aims specified are substantially achieved by a monitoring system for man-made and/or natural structures comprising the technical features described in one or more of the appended claims.

The invention describes a monitoring system for man-made and/or natural structures which comprises a plurality of sensors and a control unit.

The sensors can be installed in a building and are configured for detecting a respective plurality of ambient parameters of the building and for transmitting parametric signals representing these ambient parameters.

The control unit is configured to receive the parametric signals and is connected or connectable to a database which comprises a plurality of predetermined reference values.

The control unit is further configured for comparing the parametric signals with the plurality of predetermined reference values and for generating an alarm signal as a function of a result of the comparison.

In this way, it is possible to monitor the conditions of the building and of the rooms present inside it, quickly generating an alert signal if one or more of these conditions do not conform with predetermined threshold values.

The invention also relates to a network for monitoring the area comprising a plurality of devices according to the invention and a processing unit configured for receiving the parametric signals and/or the alarm signals from the respective plurality of control units.

The receiving unit is also configured to generate, after receiving an alarm signal, an ordered list of maintenance and/or repair and/or saving operations to be performed at the control units.

In particular, the ordered list is generated as a function of an order of priority determined by the urgency class assigned by the respective control unit.

In this way it is possible to collect in a centralised manner the information relating to the conditions of the individual buildings, providing an immediate overall view of the emergency conditions which may arise in a area and their actual seriousness.

A precise list of the operations to be carried out is also generated, ordered as a function of the actual urgency of the intervention to be performed; the above-mentioned list being updated in real time on the basis of all the possible variables for the crowding of the places, such as, for example, with regard to times, weather, seasons, holidays, events etc.

### DESCRIPTION OF THE DRAWINGS

Further features and advantages of this invention are more apparent in the non-limiting description of a preferred but non-exclusive embodiment of a monitoring system for buildings, as illustrated in the accompanying drawings, in which:

FIG. 1 shows a schematic representation of the system according to the invention;

FIG. 2 shows a schematic representation of the network according to the invention.

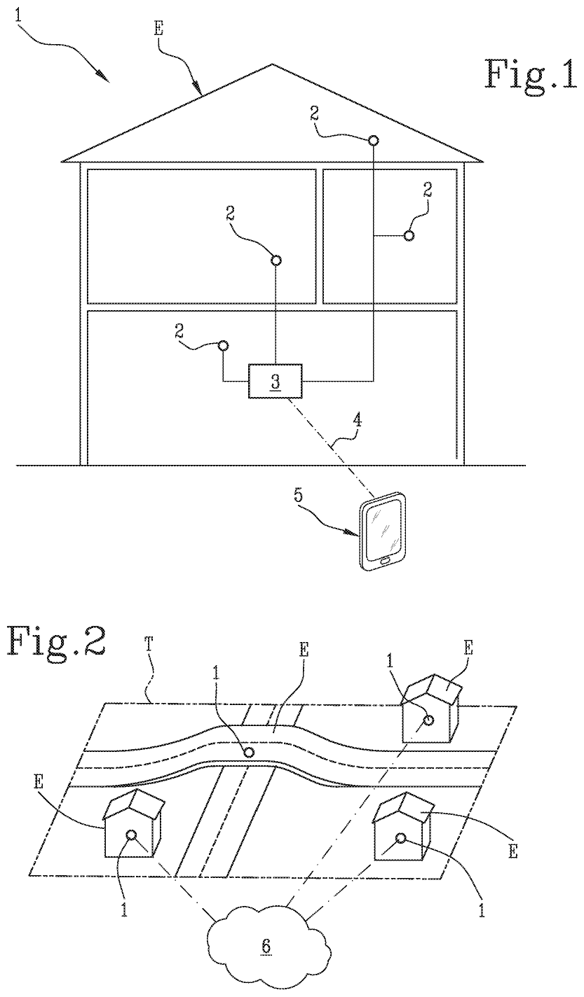

The numeral 1 in the accompanying drawings denotes a monitoring system for buildings, referred to below as system 1.

### DETAILED DESCRIPTION OF THE INVENTION

The system 1 comprises a plurality of sensors 2 and a control unit 3.

The sensors can be installed in a building “E” and are configured for detecting a respective plurality of ambient parameters of the building “E”.

The term “E” is used to mean any man-made and/or natural structure, constructions carried out by man and for which it may be of interest to perform a monitoring aimed at determining the need to carry out maintenance and repair operations, or for which it can be useful to determine the actual need for an intervention by the emergency services following a catastrophe.

For this reason, the term building “E” is used to mean both constructions designed to accommodate persons or activities linked to them or infrastructures and places of transit such as, for example, bridges, viaducts or the like.

The term “ambient parameters” is used to mean any detectable parameter useful for determining a condition of the building or the state of conservation of objects contained therein or the ambient conditions and health of persons present inside it.

By way of a non-limiting example, the ambient parameters may comprise at least one between: temperature, humidity level, position of the sensor, composition of the air, maximum deviation from the original position.

The sensors 2 are further configured for transmitting parametric signals which represent the ambient parameters measured.

In other words, the sensors 2 are able to measure the ambient parameters of the building in which they are installed, and then transmit them in the form of parametric signals which enclose the information collected.

In particular, by way of a non-limiting example, the plurality of sensors 2 may comprise at least one between: a temperature sensor, a humidity sensor, a camera, a sound detector, a gas detector, a movement sensor, an anemometer.

The control unit 3 is operatively connected to the sensors 2, to receive from them the parametric signals, the connection may be either of the wireless or wired type.

Moreover, the control unit 3 is connected or connectable to a database which comprises a plurality of predetermined reference values and is configured for comparing the parametric signals with the plurality of predetermined reference values, generating an alarm signal as a function of a result of the comparison.

In other words, the control unit 3 has access to a database in which are stored a plurality of predetermined reference values which can be associated with the various ambient parameters which the system is able to measure using the sensors 2.

In a continuous fashion, the parametric signals, which contain the information collected by the sensors relative to the ambient parameters, are compared with the predetermined reference values and the control unit 3 determines as a function of the comparison whether it is necessary or not to generate the alarm signal and activate the intervention protocol according to the priorities, for the places and the intervention forces resulting from the options generated by it.

In particular, the aim of the alarm signal is to alert a user of the occurrence of an abnormal situation wherein the ambient parameters are such as to determine a risk situation in response to which it is necessary to prepare a suitable maintenance, repair and/or saving intervention, depending on the type of anomaly detected.

The predetermined reference values stored in the database may comprise a plurality of parametric values and/or a plurality of information items relating to the building.

More in detail, the parametric values may comprise at least one between:

a temperature value, a humidity value, gas concentration, at least one spatial coordinate.

These parameters make it possible to identify the occurrence of potentially dangerous situations such as fires, collapses and other situations.

The information relating to the building may comprise at least one between: planned use of the building, times during which persons are usually present in the building, number of occupants of the building, personal details of the occupants of the building, technical data, structural characteristics and condition of the building.

The processing of these parameters determines the priority on the basis of the actual urgency with which it is necessary to intervene and also defines the quality, the intensity and the destination.

The two lists just presented are to be considered as non-limiting examples, since it is possible to consider the use of predetermined reference values which are at least partly different, depending on the particular field of application of the invention.

The control unit 3 is further configured (during final phase with a neural network and during transient phase using a software) to attribute, after the generation of an alarm signal, a class of urgency representing how urgent it is to carry out a maintenance and/or repair and/or saving operation at the control unit.

The urgency class is assigned as a function of the comparison of the parametric signals with the plurality of predetermined reference values.

In other words, following the generation of an alarm signal, the control unit 3 is not limited to determining the seriousness of the situation which has caused the generation of the alarm signal but analyses its distribution and diffusion in the area, comparing it with the simultaneous situations through which it may or may not become a hazard or an emergency.

For example, the urgency class may be determined as a function of the number of ambient parameters which can be associated with the building “E” which deviate from the predetermined reference values and/or from the extent of the difference.

For example, the control unit 3 could detect in a building “E” an excessively high temperature value, which above a respective predetermined reference value would indicate the occurrence of a fire.

Consequently, an alarm signal is generated and an urgency class is assigned as a function of the information relative to that building “E” contained in the database to which the control unit 3 refers.

If a public building “E” is taken into consideration, which may be a post office, the class of urgency will be greater in the times of maximum inflow and will be less in the times of closing of the office.

Advantageously, the control unit 3 is configured for transmitting the parametric signals and/or said alarm signal to at least one remote terminal 4.

The remote terminal 4 preferably comprises at least one between a computer or a portable electronic device.

In other words, the control unit 3 is able to quickly notify a remote terminal 4 of the occurrence of a dangerous situation in the building “E” in which the system is installed, in this way allowing the alarm signal to reach the persons concerned to intervene in order to deal with this situation.

In particular, the control unit may transmit the parametric signals and/or the alarm signal to the owner of the building “E” or to public bodies designed to intervene in emergency situations, such as, for example, police, fire service, emergency services or civil protection agency.

According to a possible embodiment, the control unit 3 comprises a legible storage support, which is configured for storing the parametric signals in such a way as to allow any subsequent analysis.

In this way it is possible to store the ambient parameters to which the building “E” has been exposed, thus allowing a logged memory to be made of any events of interest which over the years could have caused a deterioration of the conditions of the building “E”.

This data collection, managed by the system in an independent manner and unmodifiable by the owner of the property, not only constitutes a sort of archive available to the state on the real situation of the real estate assets, but may constitute a document (similar to the current energy efficiency certificates) for secure reference for each transaction and/or changes relative to the assets monitored.

The control unit 3 may also be connected to a remote storage unit, preferably a computing cloud, which is configured for storing the ambient parameters in such a way as to allow any subsequent analysis.

The implementation of the remote storage unit may be performed in combination with the presence of the legible storage medium, as backup memory present for greater security, or as a single solution for storing the information collected, thus allowing the structural complexity and the dimensions of the control unit 3 to be reduced.

Advantageously, the system according to the invention makes it possible to overcome the technical problem described above, since it allows the occurrence of a hazardous situation to be identified in a fast and efficient manner, immediately alerting the persons assigned to intervene in order to deal with the emergency which has occurred.

In the same way, the continuous monitoring of the conditions of the building “E” allows precise programming of maintenance activities aimed at preventing possible risks for the persons who usually frequent the building “E”.

Moreover, the possibility of storing the parametric signals collected over time makes it possible to generate a historical record of the conditions of the building “E” over the years, obtaining important information relating to its state of conservation and all the events which have affected it.

The invention also relates to a network 5 for monitoring an area.

The network 5 comprises a plurality of systems 1 made as described above and a processing unit 6 for receiving the parametric signals and/or the alarm signals from the respective plurality of control units 3.

That is to say, the network 5 is configured for collecting, using the processing unit 6, the information obtained from the individual control units 3 in such a way as to allow an overall analysis.

In particular, the processing unit 6 may comprise a computing cloud to which all the parametric signals and/or alarm signals generated by the control unit 3 are conveyed.

Advantageously, the use of a computing cloud allows a network to be made with a large and widespread coverage of the area to be monitored, since it is possible to make use of a wireless connection which does not require the onerous installation of special connection infrastructures.

The computing cloud may be further connected to portable terminals 4 of the same type and with the same methods described above for this type of device.

As a function of the information obtained, in particular by means of the parametric signals, the processing unit 6 is able to map the position of the individual control units 3 inside the monitored area.

The processing unit 6 is also configured to generate, after receiving an alarm signal, an ordered list of maintenance and/or repair and/or saving operations to be performed at the control units 3.

The ordered list is generated as a function of an order of priority determined by the urgency class assigned by the respective control unit 3.

In other words, the network 5 is able to determine, inside the area monitored and after receiving at least one alarm signal, which are the buildings “E” at which it is necessary to intervene and according to which order.

More specifically, the intervention order is determined as a function of the urgency class associated with the various buildings by the control units 3.

Advantageously, the network 5 according to the invention therefore makes it possible to delineate an accurate map of the operations to be prepared following the occurrence of an emergency situation.

In particular, the map provides clear indications relating to the actual urgency with which it is necessary to intervene at each building “E” in which the system according to the invention is installed.

In this way it is possible to optimise the saving, maintenance or repair operations by directing the specific authorities to the place where their intervention is most necessary.

1. A monitoring system comprising:
a plurality of sensors (2) which can be installed in a building (E) and configured for detecting a respective plurality of environmental parameters of said building (E) and for transmitting parametric signals representing said environmental parameters;
a control unit (3) configured for receiving said parametric signals;
characterised in that the control unit (3) is connected or connectable to a database, said database comprising a plurality of predetermined reference values, said control unit (3) being configured for comparing the parametric signals with the plurality of predetermined reference values and for generating an alarm signal as a function of a result of said comparison.

2. The system according to claim 1, wherein the control unit (3) is configured for assigning, after generating an alarm signal, an urgency class representing how urgent it is to perform a maintenance and/or repair and/or saving operation at said control unit (3), the urgency class being assigned as a function of the comparison of the parametric signals with the plurality of predetermined reference values.

3. The system according to claim 1, wherein the plurality of predetermined reference values comprises a plurality of parametric values, preferably said plurality of parametric values comprising at least one between: a temperature value, a humidity value, at least one spatial coordinate.

4. The system according to claim 1, wherein the plurality of predetermined reference values comprises a plurality of information items relating to the building (E), preferably said plurality of information items comprising at least one between: planned use of the building (E), times at which persons are usually present in the building (E), number of normal occupants of the building (E), personal data of normal occupants of the building (E).

5. The system according to claim 1, wherein the control unit (3) is configured for transmitting said parametric signals and/or said alarm signal to at least one remote terminal (4), said remote terminal (4) preferably comprising at least one between a computer or a portable electronic device.

6. The system according to claim 1, wherein the control unit (3) comprises a legible storage support, said legible storage support being configured for storing the parametric signals in such a way as to allow any subsequent analysis.

7. The system according to claim 1, wherein the control unit (3) is connectable to a remote storage unit, preferably a computing cloud, said remote storage unit being configured to store the environmental parameters in such a way as to allow any subsequent analysis.

8. The system according to claim 1, wherein the plurality of sensors (2) comprises at least one between: a temperature sensor, a humidity sensor, a camera, a sound detector, a gas detector, a movement sensor, an anemometer.

9. A network for monitoring the area comprising a plurality of systems (1) according to claim 1 and a processing unit (6) configured to receive the parametric signals and/or the alarm signals from the respective plurality of control units (3) and for generating, after receiving an alarm signal, an ordered list of maintenance and/or repair and/or saving operations to be carried out at said control units (3), said ordered list being generated as a function of an order of priority determined by the urgency class assigned by the respective control unit (3).

10. The network according to claim 9, wherein the processing unit (6) comprises a computing cloud, said parametric signals and/or said alarm signals being sent to said computing cloud.

11. The network according to claim 9, wherein the processing unit (6) is configured for mapping the position of the control units (3).
